(19) United States
(12) Patent Application Publication
(10) Pub. No.: US 2007/0122251 A1
(43) Pub. Date: May 31, 2007

(54) Cold-rolled fixing screw comprising a self-tapping thread

(76) Inventors: Heinrich Friederich, Gross-Rohrheim (DE); Reinhard Schmoock, Netphen (DE)

Correspondence Address: BIRCH STEWART KOLASCH & BIRCH, PO BOX 747, FALLS CHURCH, VA, 22040-0747, US

(21) Appl. No.: 10/583,324

(22) PCT Filed: Oct. 29, 2004
(86) PCT No.: PCT/EP04/12286

§ 371 Date: Feb. 16, 2007

(30) Foreign Application Priority Data
Dec. 18, 2003 (DE) 103 59 679.8

(51) Int. Cl. F16B 35/04

(52) U.S. Cl. 411/424

(57) ABSTRACT

The invention relates to a cold-rolled fixing screw consisting of a low-alloy carbon steel with a high degree of deformation according to the ratios of external diameter to core diameter of >1.2 and pitch to external diameter of >0.23, with a self-tapping thread for screwing into materials, in particular plastics. The screw material of said steel screw with a ferritic structure contains additional constituents with a substantially higher carbon content than the carbon that is contained in the ferrite. Said mixed structure has a maximum carbon content of 0.42 weight percent and a maximum grain size that corresponds to at least 2000 grain/mm², preferably at least 3000 grains/mm², with a residual stress that is impressed and maintained by the cold rolling process.

The invention relates to a cold-rolled fixing screw consisting of a low-alloy carbon steel with a high degree of deformation according to the ratios of external diameter to core diameter of >1.2 and pitch to external diameter of >0.23, with a self-tapping thread for screwing into materials, in particular plastics, consisting of a screw material with a residual stress that is impressed and maintained by the cold rolling process.

Such a fixing screw is presented and described, for example, in European patent specification 948719. During the cold rolling of this screw, there results a high degree of deformation, according to the ratios, specified in claim 1 of said patent specification, of external diameter to core diameter of 1.2 to 1.4 and pitch to external diameter of 0.23 to 0.41. According to claim 2 of the cited European patent specification, the ratio of external diameter to core diameter is 1.25 to 1.65 and the ratio of pitch to external diameter is 0.24 to 0.53. The material of this screw and the manufacturing process thereof, namely cold rolling and heat treatment, is briefly referred to in the European patent specification (see column 4, lines 39 to 49).

In addition, German patent specification 27 54 870 discloses a cold-rolled fixing screw in which there is likewise a high degree of deformation owing to the ratio of external diameter to core diameter of 1.85 and the ratio of pitch to external diameter of 0.45. With regard to the manufacturing process of the screw, the specification mentions cold rolling and, as the starting material, carbon steel with a carbon content of up to 0.35 weight percent.

A fundamental explanation of the manufacturing process of the above-described cold-rolled fixing screw is contained in the series of publications “EJOT FORUM 2, technical essays of September 1990”. Said publication makes reference on page 2, middle column, to a heat-treating equipment used for the manufacture of such screws, with which screws are heat-treated to material quality 10.9. Heat treatment in this context means the heat treatment of carbon steel, in connection with which it is stated in a table (see page 7) that the carbon steel is, if necessary, quenched with additives (after heating) and tempered. Furthermore, according to page 4, middle column, steel screws have been case-hardened in order to increase their strength, i.e. after cold forming (cold rolling), the screws are subjected to carbon nitriding in order to increase the carbon content at the surface of the screw (known case-hardening process) and thereafter to direct quenching and tempering. On page 5, middle column, it is additionally explained with reference to FIG. 4that the case-hardened screws have a higher risk of fracture than screws which have been heat-treated only to 10.9 quality. In any case, therefore, it is explained that the heat treatment of the screws, i.e. their heating, quenching and tempering, was and is the principal characteristic of the manufacturing process of such screws.

This teaching of the manufacture of the herein relevant screws, namely the use of the heat treatment process consisting of heating, quenching and tempering, is additionally confirmed in the article “Verbindungs-Trüffelschweine”, published in KEM 1994 April, page 92. In this article, it is explained on page 92: “Also self-tapping screws for plastic connections are case-hardened from steel or are made of stainless steel.” Apart from stainless steel, which is a high-alloy steel and, as such, cannot be compared with a low-alloy carbon steel and, consequently, is also not heat-treated, the upshot of the citation, as in the case of the previously discussed essay, is that self-tapping screws for plastic connections should be made of steel and then heat-treated, i.e. subjected to the process of at least being heated with subsequent quenching and tempering, in order thereby to meet the requirements of practical experience.

According to DD patent specification 272973 A1, it has also been proposed, in connection with the manufacture of standard parts of cold-drawn steel, to process the steel, unannealed, on automatic cold heading machines without subsequent heat treatment, the upshot of which is that the residual stresses impressed on the steel through cold forming are maintained in the steel.

The object of the invention is to improve the initially discussed screws with regard to their strength. The object of the invention is achieved by a screw material of steel of ferritic structure and additional constituents with a substantially higher carbon content than the carbon that is contained in the ferrite, said mixed structure having a maximum carbon content of 0.42 weight percent and a maximum grain size that corresponds to at least 2000 grains/mm2, preferably at least 3000 grains/mm2, the additional constituents being, either singly or in combination, proportions of spherically formed cementite or martensite.

During cold rolling, the grains of the mixed structure are elongated through cold forming, there building up in them a contraction stress which, unless eliminated through subsequent heat treatment, can be especially advantageously exploited as a resistance force against external application of force to the screw in the interconnected assembly. The size of the grains plays an important role inasmuch as the effect of the produced resistance as a result of cold forming is especially great when the maximum grain size is below a value which results in the case of at least 2000 grains/mm2, preferably at least 3000 grains/mm2 (DIN EN ISO 643, for USA ASTM E 112). The ratio of the carbon content in the ferritic structure and in the additional constituents may advantageously be approximately 1:10.

The screw according to the invention is also based on the realization that the residual stresses that are impressed in the screw material during cold rolling, and which run axially in the screw, form an axial residual compressive stress (contraction stress) which is exploited, when load is applied to the screw having been screwed into a plastic material, in order to increase the fatigue strength of the connection under dynamic loading of the screwed connection (fluctuating loading), since the maintained residual compressive stress runs in the opposite direction to the external tensile stresses which occur during operation. This effect of maintaining the impressed residual stresses/residual compressive stresses, which has proved decisive for the special resistance of the screw according to the invention, is the result of the deliberate omission of subsequent heat treatment, i.e. heating, quenching and tempering, of the cold-rolled screw, which—and this has hitherto been completely overlooked—would remove the residual stress, which has shown itself above to be especially useful. Consequently, the fact that the manufacturing process of the screws according to the invention is terminated immediately after cold rolling without further heat treatment results in a substantial simplification of the manufacturing process, this additionally leading, as already stated, to the particular strength of the screw.

As additional constituents of the fixing screw according to the invention one can advantageously use, either singly or in combination, proportions of spherically formed cementite, lamellar perlite, bainite or martensite. The ratio of the carbon content in the ferritic structure and in the additional constituents may advantageously be approximately 1:10. During cold rolling, the grains of the mixed structure are elongated through cold forming, there building up in them a contraction stress which, unless eliminated through subsequent heat treatment, can be especially advantageously exploited as a resistance force against external application of force to the screw in the interconnected assembly. The size of the grains plays an important role inasmuch as the effect of the produced resistance as a result of cold forming is especially great when the maximum grain size is below a value which results in the case of at least 2000 grains/mm2, preferably at least 3000 grains/mm2 (DIN EN ISO 643, for USA ASTM E 112).

The screw material can advantageously be further improved with regard to its strength properties by means of admixtures. For this purpose, there are the following possibilities of adding admixtures, either singly or in any desired combination, to the screw material. These are manganese in 0.6 to 2.0 weight percent, silicon in max. 1.2 weight percent, chromium in max. 2 weight percent, molybdenum in max. 1 weight percent, vanadium in max. 0.5 weight percent, boron in max. 0.008 weight percent, niobium in max. 0.15 weight percent and titanium in max. 0.3 weight percent.

1. (canceled)

2. (canceled)

3. (canceled)

4. (canceled)

5. (canceled)

6. (canceled)

7. (canceled)

8. (canceled)

9. (canceled)

10. (canceled)

11. Cold-rolled fixing screw consisting of a low-alloy carbon steel with a high degree of deformation according to the ratios of external diameter to core diameter of >1.2 and pitch to external diameter of >0.23, with a self-tapping thread for screwing into materials, in particular plastics, consisting of a screw material with a residual stress that is impressed and maintained by the cold rolling process, characterized by a screw of steel of ferritic structure and additional constituents with a substantially higher carbon content than the carbon that is contained in the ferrite, said mixed structure having a maximum carbon content of 0.42 weight percent and a maximum grain size that corresponds to at least 2000 grains/mm², preferably at least 3000 grains/mm², the additional constituents being, either singly or in combination, proportions of spherically formed cementite or martensite.

12. Fixing screw according to claim 1, characterized in that manganese is added in 0.60-2.0 weight percent to the screw material.

13. Fixing screw according to claim 1, characterized in that silicon is added in max. 1.2 weight percent to the screw material.

14. Fixing screw according to claim 1, characterized in that chromium is added in max. 2 weight percent to the screw material.

15. Fixing screw according to claim 1, characterized in that molybdenum is added in max. 1 weight percent to the screw material.

16. Fixing screw according to claim 1, characterized in that vanadium is added in max. 0.5 weight percent to the screw material.

17. Fixing screw according to claim 1, characterized in that boron is added in max. 0.008 weight percent to the screw material.

18. Fixing screw according to claim 1, characterized in that niobium is added in max. 0.15 weight percent to the screw material.

19. Fixing screw according to claim 1, characterized in that titanium is added in max. 0.3 weight percent to the screw material.

20. Fixing screw according to claim 2, characterized in that silicon is added in max. 1.2 weight percent to the screw material.

21. Fixing screw according to claim 2, characterized in that chromium is added in max. 2 weight percent to the screw material.

22. Fixing screw according to claim 3, characterized in that chromium is added in max. 2 weight percent to the screw material.

23. Fixing screw according to claim 2, characterized in that molybdenum is added in max. 1 weight percent to the screw material.

24. Fixing screw according to claim 3, characterized in that molybdenum is added in max. 1 weight percent to the screw material.

25. Fixing screw according to claim 4, characterized in that molybdenum is added in max. 1 weight percent to the screw material.

26. Fixing screw according to claim 2, characterized in that vanadium is added in max. 0.5 weight percent to the screw material.

27. Fixing screw according to claim 3, characterized in that vanadium is added in max. 0.5 weight percent to the screw material.

28. Fixing screw according to claim 4, characterized in that vanadium is added in max. 0.5 weight percent to the screw material.

29. Fixing screw according to claim 5, characterized in that vanadium is added in max. 0.5 weight percent to the screw material.

30. Fixing screw according to claim 2, characterized in that boron is added in max. 0.008 weight percent to the screw material.
